(19) United States
(12) Patent Application Publication
(10) Pub. No.: US 2025/0139505 A1
(43) Pub. Date: May 1, 2025

(54) ESTIMATION OF PROCESS LEVEL ENERGY CONSUMPTION

(71) Applicant: DELL PRODUCTS L.P., Round Rock, TX (US)

(72) Inventors: Nikhil Vichare, Austin, TX (US); Farzad Khosrowpour, Pflugerville, TX (US)

(21) Appl. No.: 18/499,442

(22) Filed: Nov. 1, 2023

(51) Int. Cl. G06N 20/00

(52) U.S. Cl. CPC G06N 20/00

(57) ABSTRACT

An information handling system stores a batch of energy data, and receives different sets of energy data from different components. The system stores the different sets of energy data as the batch of energy data. The system provides the batch of energy data to an input layer of a machine learning model and executes the machine learning model. Based on the execution of the machine learning model, the system determines energy consumption by the different components.

### FIELD OF THE DISCLOSURE

The present disclosure generally relates to information handling systems, and more particularly relates to estimating process level energy consumption in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store a batch of energy data for the information handling system. A processor may receive different sets of energy data from different components of the information handling system. The processor may store the different sets of energy data as the batch of energy data in the memory. The processor may provide the batch of energy data to an input layer of a machine learning model and execute the machine learning model. Based on the execution of the machine learning model, the processor may determine an amount of energy consumption by the different components.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system including an information handling system and a cloud server according to at least one embodiment of the present disclosure;

FIG. 2 is a block diagram of a machine learning model according to at least one embodiment of the present disclosure;

FIG. 3 is a flow diagram of a method for training a machine learning model according to at least one embodiment of the present disclosure;

FIG. 4 is a flow diagram of a method for determining energy consumption for a process according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

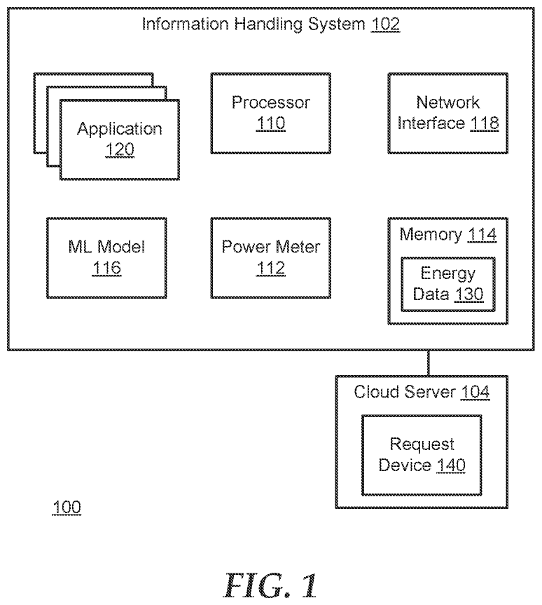

FIG. 1 illustrates a system 100 including multiple information handling systems 102 and a cloud server 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110, a power meter 112, a memory 114, a machine learning model 116, a network interface card 118, one or more applications 120. Cloud server 104 includes a request device 140. In an example, memory 114 may store any suitable data associated with the components of information handling system 102, such as energy data 130. Information handling system 102 may include additional components without varying from the scope of this disclosure.

In an example, power meter 112 may estimate an amount of power consumed by each process or executed application 120. The estimated amount of power may be consumed by processor 110, memory 114, and network interface card 118 during the execution of application 120. In previous information handling systems, the amount of power consumption estimated by power meter 112 may be accurate the majority of the time on average but can be off by a large percentage, such as 40%, in some categories depending on specific application workloads. These categories may include power estimates in network interface card 118. These errors are pronounced when the applications have heavy network workloads. In previous information handling systems, the power meter provides the most accurate estimates for a processor. However, power estimates for the processor may be inconsistent and problematic in system power behavior analysis. Information handling system 102 may be improved by accurately estimating the overall energy and the process level energy data during runtime of information handling system 102.

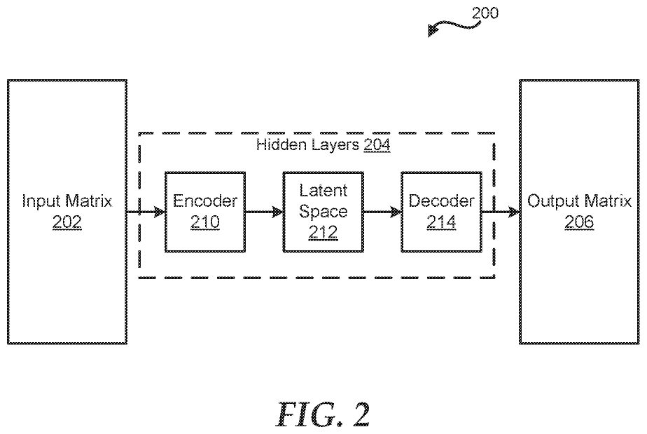

During runtime of information handling system 102, different components or applications 120 may collect energy data 130. For example, power meter 112 may collect process level energy data with a breakdown by device within information handling system 102. In an example, a particular application 120, such as a telemetry platform, may collect process utilization data. The process utilization data may include process level energy consumption of components within information handling system, such as processor 110, memory 114, network interface card 118, or the like. Energy data 130 may also include power data, such as actual power data in Watts on a system and device level. In an example, energy data 130 may also include a system config for information handling system 102 including detailed attributes of the system configuration and specifications of the information handling system. In certain examples, energy estimation engine process power may be available only during training using power meter 112 or other instrumentation and telemetry. Training of ML model 116 will be described with respect to FIG. 2 below.

FIG. 2 illustrates a ML model 200 according to at least one embodiment of the present disclosure. ML model 200 may be substantially similar to ML model 116 of FIG. 1. ML model 200 includes an input layer 202, one or more hidden layers 204, and an output layer 206. Hidden layers 204 may include an encoder 210, latent space 212, and a decoder 214.

In an example, an input matrix may be received at input layer 202. In certain examples, the input matrix may be generated or created from any suitable energy data associated with an information handling system, such as information handling system 102 of FIG. 1. In certain examples, process level energy data may be collected per hardware platform or for a select number of platforms per generation of an information handling system, such as information handling system 102 of FIG. 1. In an example, different workloads may be run during the development phases of the hardware. Various workloads may be tested on the hardware under test. In certain examples, the workloads may include benchmarks as well as various concurrent customer workloads. When the workloads are running, the hardware may be monitored by a power meter chip or other sensors to collect energy datasets.

In certain examples, datasets across multiple runs and hardware may be aggregated into a single training dataset to train hidden layers 204. In an example, the training of hidden layers 204 may be performed in any suitable manner including, but not limited to, supervised learning, unsupervised learning, reinforcement learning, and self-learning. For example, if hidden layers 204 are trained via supervised learning, an individual may provide an input matrix associated with power consumption of components and a process within an information handling system along with process power from an energy estimation engine or application for that information handling system. In an example, any machine learning model may be utilized for determining a user experience including, but not limited to, an encoder-decoder model. Execution of ML model 200 will be described with respect to ML model 116 of FIG. 1.

Referring back to FIG. 1, ML model 116 may be embedded with an on-client application 120, such as a telemetry platform or optimizer application. In an example, ML model 116 also may be hosted on a platform application on cloud server 104 to provide updates and model management. During runtime, processor 110 may receive an energy consumption request from any suitable component. For example, the energy consumption request may be received from request device 140 of cloud server 104, application 120, or the like. In response to the energy consumption request, processor 110 may schedule ML model 116 to execute on a batch of energy data. Processor 110 may then execute ML model 116 based on the schedule. In certain examples, an interval of the energy consumption request for a batch energy data may be any suitable amount of time from every few seconds to days in length. The interval may depend on a use case and local application 120 or cloud application, such as request device 140, requesting the data. In an example, ML model 116 may be optimized to run on or be executed by an embedded controller of information handling system 102.

In certain examples, different sets of energy data 130 may be combined into a single batch of energy data to be provided to ML model 116. The batch of energy data 130 may be complied or generated a process power matrix. In an example, ML model 116 may characterize the process-power matrix to assign the power values by process and by device. In certain examples, processor 110, via ML model 116, may determine or estimate the power values or energy consumption without assumptions on the type of process, workload, or the type of hardware. In an example, both hardware and workload features may be part of hidden layers of ML model 116.

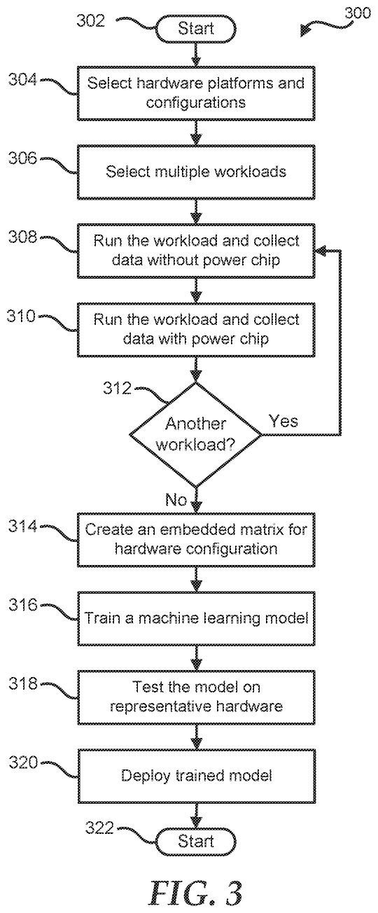

FIG. 3 is a flow diagram of a method 300 for training a machine learning model according to at least one embodiment of the present disclosure, starting at block 302. In an example, method 300 may be performed by any suitable component including, but not limited to, processor 110 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 304, different hardware platforms and configurations for an information handling system are selected. At block 306, multiple workloads are selected. In an example, the different workloads may cause different processes to be performed in components of the information handling system, and the different workloads may result in different energy consumptions. At block 308, a workload is run or executed, and energy data is collected without use of a power meter.

At block 310, the workload is run or executed, and energy data is collected with the power meter. At block 312, a determination is made whether another workload is left to be run or executed. If another workload is left, the flow continues as stated above at block 308. If no other workload is left, one or more embedded matrices are created for the hardware configuration at block 314. In an example, the different types of energy data collected may be complied in different matrices or in a single matrix. The energy data collected in block 310 may be compiled or otherwise utilized to generate a matrix of power values per device and process.

At block 316, a ML model is trained based on the embedded matrices. In an example, the ML model may be an encoder-decoder model. At block 318, the ML model is tested on representative hardware. In an example, the testing of the ML model may validate overall energy consumption numbers may be system and device level power data. At block 320, the trained ML model is deployed, and the flow ends at block 322. In an example, the ML model may be deployed by providing or distributing the trained ML model to multiple information handling systems.

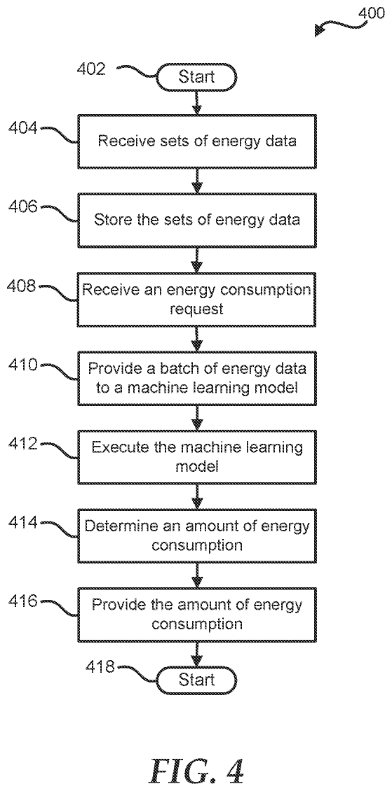

FIG. 4 is a flow diagram of a method 400 for determining an energy consumption for a process according to at least one embodiment of the present disclosure, starting at block 402. In an example, method 400 may be performed by any suitable component including, but not limited to, processor 110 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 404, sets of energy data are received. In an example, the sets of energy data may be received from different components of an information handling system, such as a power meter, applications, or the like. At block 406, the sets of energy data are stored in a memory of the information handling system. In certain examples, the sets of energy data may be utilized to create one or more matrices and the matrices may be stored in the memory.

At block 408, an energy consumption request is received. In an example, the energy consumption request may be received from an application in the information handling system, from a request device of a cloud server, or the like. At block 410, a batch of energy data is provided to a ML model. In certain examples, the batch of energy data may be one or more matrices of energy data stored in the memory of the information handling system.

At block 412, the ML model is executed. In an example, the batch of energy data is provided as an input to the ML model. At block 414, an amount of energy consumption is determined. In certain examples, hidden layers of the ML model may perform one or more operations on the batch of energy data to determine the energy consumption. At block 416, the determined energy consumption is provided to the device that sent the energy consumption request.

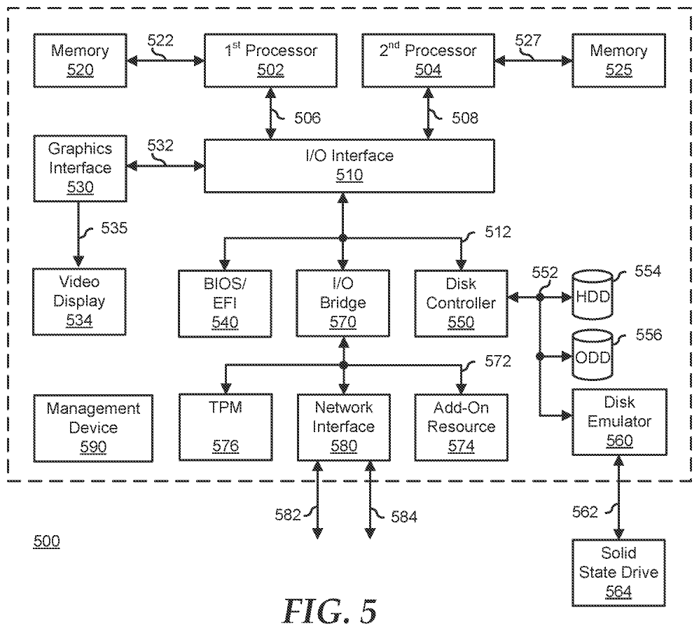

FIG. 5 shows a generalized embodiment of an information handling system 500 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a batch of energy data for the information handling system; and
a processor to communicate with the memory, wherein the processor to:
receive different sets of energy data from different components of the information handling system;
store the different sets of energy data as the batch of energy data in the memory;
provide the batch of energy data to an input layer of a machine learning model;
execute the machine learning model; and
based on the execution of the machine learning model, determine an amount of energy consumption by the different components.

2. The information handling system of claim 1, wherein the different sets of energy data correspond to a single process executed across all of the different components.

3. The information handling system of claim 1, wherein the processor further to:
execute multiple workloads within the different components;
collect a first set of data based on the execution of the multiple workloads;
collect a second set of data based on the execution of the multiple workloads; and
train the machine learning model with the first and second sets of data.

4. The information handling system of claim 3, wherein the processor further to:
generate a matrix using the first and second sets of data; and
provide the matrix as training data to the machine learning model.

5. The information handling system of claim 1, wherein prior to the batch of energy data being provided to the machine learning model, the processor further to: receive an energy consumption request from a request component.

6. The information handling system of claim 5, wherein in response to the amount of energy consumption being determined, the processor further to: provide the amount of energy consumption to the request component.

7. The information handling system of claim 5, wherein the request component is located within a cloud server.

8. The information handling system of claim 1, wherein the different components includes a network interface card, the memory, and the processor.

9. A method comprising:
receiving, by an information handling system, different sets of energy data from different components of the information handling system;
storing the different sets of energy data as a batch of energy data in the information handling system;
providing the batch of energy data to an input layer of a machine learning model;
executing the machine learning model; and
based on the executing of the machine learning model, determining an amount of energy consumption by the different components.

10. The method of claim 9, wherein the different sets of energy data correspond to a single process executed across all of the different components.

11. The method of claim 9, wherein the method further comprises:
executing multiple workloads within the different components;
collecting a first set of data based on the execution of the multiple workloads;
collecting a second set of data based on the execution of the multiple workloads; and
training the machine learning model with the first and second sets of data.

12. The method of claim 11, wherein the method further comprises:
generating a matrix using the first and second sets of data; and
providing the matrix as training data to the machine learning model.

13. The method of claim 9, wherein prior to the providing of the batch of energy data to the machine learning model, the method further comprises receiving an energy consumption request from a request component.

14. The method of claim 13, wherein in response to the amount of energy consumption being determined, the method further comprises providing the amount of energy consumption to the request component.

15. The method of claim 13, wherein the request component is located within a cloud server.

16. The method of claim 9, wherein the different components include a network interface card, a memory, and a processor.

17. A method comprising:
executing multiple workloads within different components of an information handling system;
collecting a first set of data based on the execution of the multiple workloads;
collecting a second set of data based on the execution of the multiple workloads;
training a machine learning model with the first and second sets of data;
storing different sets of energy data from the different components as a batch of energy data;
receiving an energy consumption request from a request component;
in response to the energy consumption request, providing the batch of energy data to an input layer of the machine learning model;
executing the machine learning model; and
based on the executing of the machine learning model, determining an amount of energy consumption by the different components.

18. The method of claim 17, wherein the different sets of energy data correspond to a single process executed across all of the different components.

19. The method of claim 17, wherein the method further comprises:
generating a matrix using the first and second sets of data; and
providing the matrix as training data to the machine learning model.

20. The method of claim 17, wherein in response to the amount of energy consumption being determined, the method further comprises providing the amount of energy consumption to the request component.
